(19) United States
(12) Patent Application Publication
(10) Pub. No.: US 2003/0030738 A1
(43) Pub. Date: Feb. 13, 2003

(54) On-chip 2D adjustable defective pixel filtering for CMOS imagers

(76) Inventors: Steven Derrick Clynes, Allen, TX (US); Zhiliang Julian Chen, Plano, TX (US); Anli Liu, Plano, TX (US)

Correspondence Address: Dennis Moore, Texas Instruments Incorporated, M/S 3999, P.O. BOX 655474, Dallas, TX, 75265, US

(21) Appl. No.: 09/862,523

(22) Filed: May 22, 2001

(51) Int. Cl. H04N 5/335

(52) U.S. Cl. 348/308

(57) ABSTRACT

The invention provides for the filtering of pixel defects from CMOS imagers. The invention comprises scanning each of a plurality of pixels within a block (420), and designating a pixel as a process pixel (430). The process pixel is then compared to adjacent pixels to see if the process pixel value deviates significantly from an adjacent pixel value (450), to determine if error correction is needed.

### CROSS-REFERENCE TO RELATED APPLICATIONS

This patent is related to and claims priority from copending U.S. patent application No. (TI-29034), entitled Defective Pixel Filtering For Digital Imagers, Ser. No. 09/475,652 filed on Dec. 30, 1999, and from copending U.S. Patent Application No. (TI-31655), entitled Image Sensor Array Readout For Simplified Image Compression, Ser. No. 09/750,400 filed on Dec. 28, 2000, the teachings of which are incorporated herein by reference.

### TECHNICAL FIELD OF THE INVENTION

The invention relates generally to image processing and, more particularly, to defective pixel filtering for CMOS imagers.

### BACKGROUND OF THE INVENTION

Problem Statement

The success of 2D sensor development has permitted relatively high levels of chip integration, so that several circuit blocks, such as timing control, PGA, and ADC, for example, can be provided together with a 2D sensor array on a single integrated circuit chip. A CMOS array sensor can be fabricated in standard CMOS processes and thus it can be integrated with other system chip such as A/D, DSP chip, etc. In addition to the possibility of integration, a CMOS array sensor (or CMOS imager) can operate in a single low supply voltage such as 3.3 V and 5 V. Furthermore, the cost of CMOS is also cheaper than that of historical imagers, and the power consumption of CMOS imager is lower than that of historical imagers. However, the use of CMOS imagers has come with a problem of image flaws caused by defective pixels, called point defects.

Each pixel in a CMOS imager typically comprises at least a diode and three transistors. A defective diode or transistor leads to a defective pixel, and the defective pixel is the detected point defect. Point defects can cause white spots and/or dark spots on an image. These white and dark spots result in “spot-noise” appearing on an image. A dark spot is a pixel that is always dark, no matter how much light shines on it. A white spot is a pixel that is always white, no matter how little light shines on it. In CMOS imagers, white spots are due to pixels with excessive leakage currents, and dark spots are caused by defects in the pixel electronics. However, it should be understood that dark spots can be caused by particles covering pixels, as well. Spot-noise seriously limits the yield of CMOS imagers and results in increasing CMOS imager costs.

Additionally, it is now common to take process image data from imagers, and compress the resultant image. Common compressions include JPEG and MPEG file compressions. In general, these compression methodologies split the image into blocks of 8×8 pixels, then transpose the 8×8 block into the frequency domain using discrete cosine transforms (DCT). Spot noise within the image generates high frequency components, which after compression and then subsequent decompression, yield undesirable image artifacts.

Accordingly, there is needed a method and devices for correcting spot-noise on CMOS imagers. The present invention provides such solutions as defined in the claims.

### SUMMARY OF THE INVENTION

The present invention achieves technical advantages as systems, devices, and methods for correcting spot noise in CMOS imagers. In one embodiment a method of pixel filtering for CMOS imagers is disclosed. The method includes the acts of scanning each of a plurality of pixels within a block, designating a pixel as a process pixel, and comparing the process pixel value to at least one adjacent pixel value. Additional functionality can be realized from the invention by detecting a lowest pixel value and/or a highest pixel value among the adjacent pixels, and then by comparing the process pixel value to the lowest and/or highest pixel value. Furthermore, the method may reset the process pixel value to a new process pixel value when the process pixel value is a predetermined value lower than the lowest pixel value, or a predetermined value higher than the highest pixel value. In one embodiment, the new process pixel value is the average pixel value of the adjacent pixel values. By filtering the high frequency spot noise prior to image compression better overall image quality and compression ratios can be achieved.

In another embodiment, the invention is a chip that automatically filters defective pixels in a CMOS imager. Generally, the chip maintains a plurality of registers, and filter logic coupled to the registers. In one embodiment, the filter logic is capable of designating a pixel as a process pixel, designating other pixels as adjacent pixels. The process pixel has a process pixel value, and each of the adjacent pixels has an adjacent pixel value. The filter logic also compares the process pixel value to at least one adjacent pixel value. In one embodiment, the chip is coupled to an CMOS image array.

In another embodiment, the invention is a method of on-chip pixel filtering for CMOS imagers. The method scans each of a plurality of pixels within a block for a pixel value, loads a pixel value into a register, and uses filter logic to designate a pixel as a process pixel. Filter logic also designates adjacent pixels, and uses filter logic to compare the process pixel value to at least one adjacent pixel value. The filter logic then compares the process pixel value to a highest pixel value and/or a lowest pixel value, and resets the process pixel value to a new process pixel value when the process pixel value is a predetermined value higher or lower than the highest pixel value. Preferably, the new process pixel value is the average pixel value of the adjacent pixel values.

### BRIEF DESCRIPTION OF THE DRAWINGS

Features of the invention will be apparent to those skilled in the art from the following detailed description of the invention, which should be read in conjunction with the accompanying drawings, in which:

FIG. 1 is a block-diagram of a CMOS imager chip configured according to the invention;

FIG. 2 is a block diagram of a CMOS Imager chip with On-Chip Adjustable Defective Pixel Filtering (OCADPF) implementation shown in greater detail;

FIG. 3 is a block-flow diagram of a pixel correction algorithm;

FIG. 4 provides a logic-flow for a pixel correction algorithm;

FIG. 5 is a preferred scanning pattern;

FIG. 6 illustrates an evaluation block, which is a bock of 3×3 pixels used for process pixel evaluation;

FIG. 7 illustrates the first three horizontal rows of a bock of 8×8 pixels;

FIG. 8 shows the relationship between active pixels and substitution pixels at boundaries of an array, using the pixel designation provided for the 8×8 (m×n) pixel block of FIG. 7; and

FIG. 9 shows the possible pixel value relationships between adjacent pixels.

### AN EXEMPLARY EMBODIMENT OF THE BEST MODE

The invention provides on-chip real time elimination of the effect of white and dark pixels, and thus increases the imager yield and decrease CMOS Imager cost. The invention comprises scanning each of a plurality of pixels within a block, and designating a pixel as a process pixel. The process pixel is then compared to adjacent pixels to see if the process pixel value deviates significantly from an adjacent pixel value, to determine if error correction is needed. If error correction is needed then the method provides for error correction. Accordingly, the invention is an On-Chip 2D Adjustable Defective Pixel Filtering (2DOCADPF) method of real-time filtering out defective pixels (or other similar spot-noise).

When reading this section (An Exemplary Embodiment of the Best Mode, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure or an exemplary act that a substantially equivalent structure or substantially equivalent act may be used to either achieve the same results in substantially the same way, or to achieve the same results in a not dissimilar way. Accordingly, the recitation of a species invokes the genus to which that species belongs as well as related species in that genus. Likewise, the recitation of a genus invokes the species known in the art. Furthermore, it is recognized that as technology develops, a number of additional ways to achieve an aspect of the invention may arise. Such advances are hereby incorporated within their respective genus should be recognized as being functionally equivalent or structurally equivalent to the aspect shown or described.

Second, aspects of the invention, including elements, acts, functions, and relationships (shown or described) should not be interpreted as being essential unless they are explicitly described and identified as being essential. The only essential aspects of the invention are identified by the claims. Third, a function or an act should be interpreted as incorporating all modes of doing that act or function, unless otherwise explicitly stated. For example, “tacking” may be done by nailing, stapling, gluing, hot gunning, riveting, etc. Fourth, unless explicitly stated otherwise, conjunctive words (such as “or”, “and”, “including”, and “comprising”) should be interpreted in the inclusive, not the exclusive, sense. Fifth, the words “step” and “means” are provided to facilitate the reader's understanding and do not mean “means” or “step” as defined in §112, paragraph 6 of 35 U.S.C. unless used as “means for -functioning-” or “step for -functioning-” in the claims section.

Integrated CMOS Imager chips provide image reception and image processing capabilities on a single chip. FIG. 1 is a block-diagram of a CMOS imager chip 120 configured according to the invention. In general, the CMOS imager chip 120 includes an array 110 of diodes and transistors. In general, light reaches the array 110, and the array 110 translates the light received into electrical signals that are reproducible as an image. To provide the ability to translate the light into an electrical signal, a grouping of a diode and transistors is provided for each pixel. Accordingly, as light reaches a pixel, that pixel converts the light into an electrical signal that is indicative of the light's intensity (brightness), darkness, and/or color. For monochrome systems, a pixel may have only one indication of a darkness or intensity, and this is called the pixel's value. Accordingly, each pixel in a monochrome system has a pixel value, and this pixel value indicates to the system the color or brightness that the pixel received, and that should be reproduced when the image is reproduced.

The electrical signals embodied in the pixel are passed from the array 110 to a bank of registers 122. The registers 122 store electrical signals indicative of pixel values for a temporary period of time, and in a manner that allows the pixel values to be accessed by a logic 124. In a preferred embodiment, the registers 122 store pixel values in a FIFO manner, and pass pixel values onto a processor 126 for processing and evaluation. The logic 124 is preferably a filter logic that preferably replaces high and/or low value pixels with a more reasonable pixel values. Logic 124 can be implemented directly on the chip 120 via circuit fabrication, or the logic 124 could be implemented via programming, such as through a programmable DSP. Likewise, the processing 126 can be achieved by any processing system, including integrated DSPs and integrated dedicated processing platforms, for example.

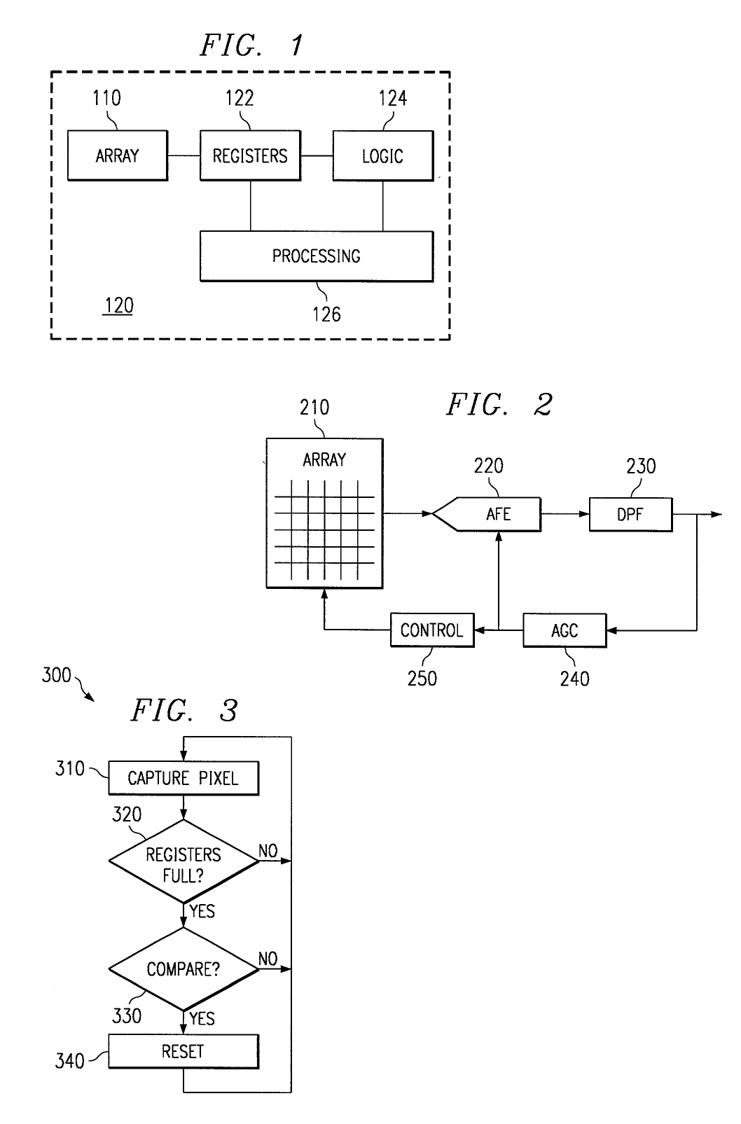

FIG. 2 is a block diagram of a CMOS Imager chip with On-Chip Adjustable Defective Pixel Filtering (OCADPF) implementation shown in greater detail. In Figure, 2 a CMOS imager array (the array) 210 receives light that produces an image. The array 210 then passes information indicative of the image to an analog front end (AFE) 220 that translates the received voltages from the array into digital signals. These digital signals are then passed to a defective pixel filter (DPF) 230, that filters out pixel noise from the image according to the invention. The output of the DPF 230 feeds an automatic gain control (AGC) 240. The AGC 240 tracks the gain in the offset. The output of the AGC 240 feeds the AFE 220 (to control the offset) and a control block 250. The control block 250 dictates exposure time, and a wide variety of other features that are beyond the scope of the present discussion. Due to process non-uniformity and device's mismatch, a Correlated Double Sampling (CDS) operation is usually needed to achieve a high quality CMOS 2D sensor.

On Chip pixel defect correction may be better understood by the examination of an adjustable defective pixel correction algorithm. FIG. 3 is a block-flow diagram of a pixel correction algorithm 300. Pixel correction algorithm 300 begins with a capture pixel act 310 in which a pixel value is transferred to a register. It should be understood that, although the word capture is used to describe the capture pixel act, the term “capture” does not necessarily imply the loading of a pixel value into a memory, as may be implied in some prior art. After a pixel value is transferred to a register in the capture pixel act 310, the pixel correction algorithm 300 proceeds to a register full query 320. The register full query 320 determines whether the registers that store adjacent pixel values (which are needed for determining an average pixel value to correct a process pixel) do in fact have pixel values associated with them. Accordingly, if each such register has a pixel value associated with it, then the pixel correction algorithm 300 proceeds along the y (or “yes”) path to a compare query 330. If, however, additional registers need pixel values for proper process pixel processing, then the pixel correction algorithm 300 proceeds along the n (“no”) path and returns to the capture pixel act 310 where another pixel value is transferred to a register.

Accordingly, the pixel correction algorithm 300 loads the registers that are needed for proper process pixel processing and then proceeds to compare a process pixel value to the pixel values of the adjacent pixels in the compare query 330. If in the compare query 330 it is determined that the process pixel does not lie outside of a threshold range beyond a highest adjacent pixel value, and that the process pixel value does not lie outside of a threshold range beyond a lowest adjacent pixel value, then the pixel correction algorithm 300 returns to the capture pixel act 310 and another pixel value is transferred to a register. If, however, the compare query 330 determines that the process pixel value lies outside of a threshold beyond either a highest adjacent pixel value or a lowest adjacent pixel value, then the pixel correction algorithm 300 proceeds along the y path to a reset act 340.

In the reset act 340 the process pixel is replaced by a new pixel value. Preferably, the new pixel value is the average pixel value of the adjacent pixels. However, it should be understood that the new process pixel value may be determined in other ways as discussed below. It should be noted that the horizontal nature of the flow of FIG. 3 is shown to emphasize that the preferred processes of FIG. 3 are occurring simultaneously (or, in parallel), preferably as a result of on-chip processing. However, it should be understood that the pixel correction algorithm 300 may also be accomplished as software.

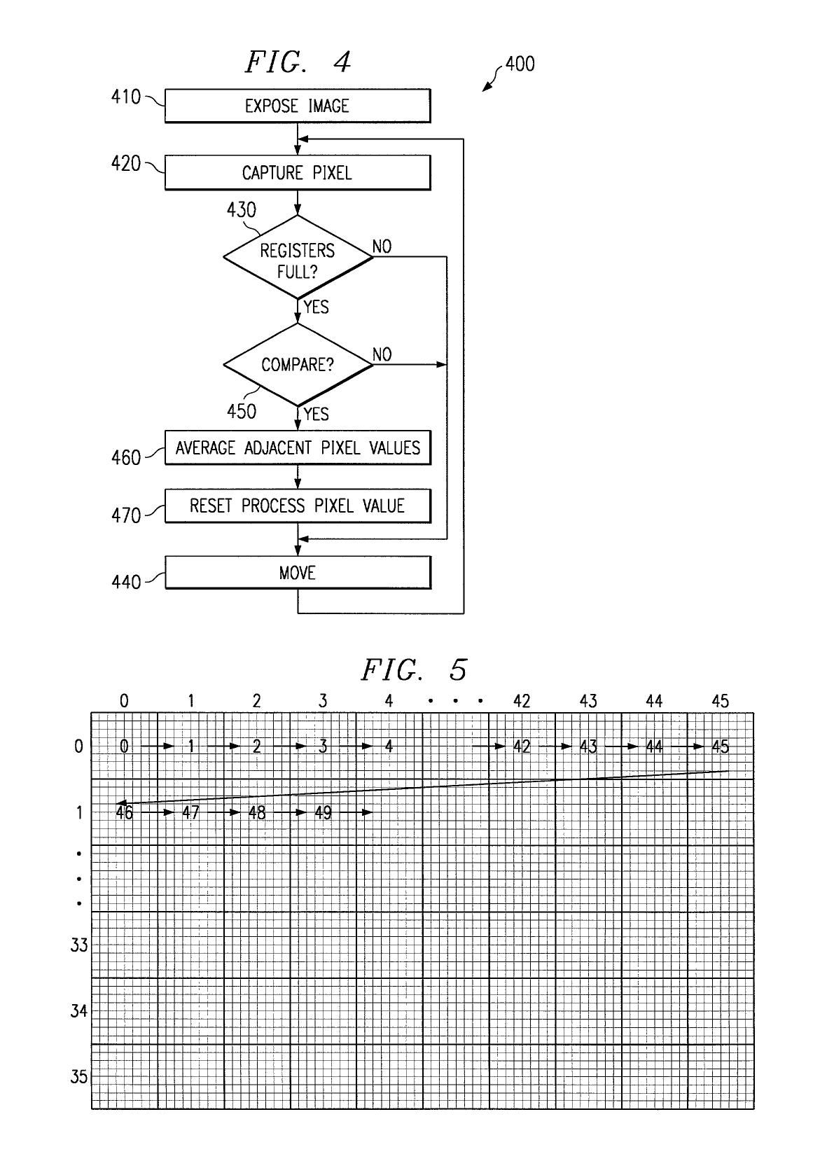

FIG. 4 provides a logic-flow for a pixel defect correction algorithm 400. The pixel defect correction algorithm 400 begins with an exposed image act 410 in which an array is exposed to light so that each pixel in the array generates an electric impulse (or, electric signal) indicative of the light intensity and wave length that reaches the pixel. These pixel characteristics are thus embodied as an electronic pixel value. However, it should be understood that the pixel value may indicate color, brightness, darkness, contrast, and/or a variety of other pixel qualities.

Next, in a capture pixel act 420, the pixel value is transferred to a register preferably co-located on the same chip as the array. The capture pixel act 420 preferably begins by capturing the top left most pixel in the array. The register full query 430 determines whether the registers that store adjacent pixel values (which are needed for determining an average pixel value to correct a process pixel) do in fact have pixel values associated with them. Accordingly, if each such register has a pixel value associated with it, then the pixel defect correction algorithm 400 proceeds along the y (or “yes”) path to a compare query 450. If, however, additional registers need pixel values for proper process pixel processing, then the pixel correction algorithm 300 proceeds along the n (“no”) path advances to a move act 440.

The move act 440 increments to the next pixel of the array, preferably incrementing horizontally from left to right in rows, so that when the last pixel in a row is captured, the move act 440 returns to the far left of the array and increments one row down from the previously captured row. Then, after the move act 440, the pixel defect correction algorithm 400 returns to the capture pixel act 420.

Accordingly, the pixel defect correction algorithm 400 loads the registers that are needed for proper process pixel processing and then proceeds to compare a process pixel value to the adjacent pixel values in a compare query 450. If in the compare query 450 it is determined that the process pixel does not lie outside of a threshold range beyond a highest adjacent pixel value, and that the process pixel value does not lie outside of a threshold range beyond a lowest adjacent pixel value, then the pixel defect correction algorithm 400 advances to the move act 440. If, however, the compare query 450 determines that the process pixel value lies outside of a threshold beyond either a highest adjacent pixel value or a lowest adjacent pixel value, then the pixel defect correction algorithm 400 proceeds along the y path to an average adjacent pixels act 460.

In the average adjacent pixel values act 460 the pixel values for the pixels adjacent to the process pixel (or their substitutions, as discussed below) are average. However, it should be understood that in the average adjacent pixel values act other forms of pixel value substitutions for the process pixel may be selected by a user. Then, the pixel defect correction algorithm 400 proceeds to a reset process pixel value act 470 in which the process pixel value that was captured is replaced (or reset) to the pixel value generated in the average adjacent pixel values act 460. Then, the pixel defect correction algorithm 400 advances to the move act 440.

Example of 2DOCADPF Operation:

To enable on chip discrete cosine transformation, pixels are read from an array in an 8×8 configuration. Reading from the array in 8×8 blocks of pixels minimizes memory requirements and reduces processing requirements since most digital chips are based on octets, however, it should be understood that other sized blocks may optimize the operation of other chips, and these block sizes are envisioned within the scope of the invention. 2DOCADPF is performed within each 8×8 (m×n) block of pixels thus reducing the amount of pixel memory required [typically, (2×m)+2 pixels]. Within the array, 8×8 (m×n) blocks are scanned, preferably in a pattern that is optimal for the type of image being processed. For monochrome images, the preferred scanning pattern of FIG. 5 is desired.

In FIG. 5 it is seen that the scanning pattern starts at the upper-left-most corner of the array, scans a block of 8×8 pixels, then proceeds horizontally to scan the next-right block of 8×8 pixels. This right-step movement of block scanning continues until the scanning reaches the right-most end of the array. Then, when no more blocks of 8×8 pixels remain to the right of the presently scanned block of 8×8 pixels, the scan returns to the left-most end of the array, and steps down one bock of 8×8 pixels (directly below a previously scanned block of 8×8 pixels). Then, the scanning proceeds in the same right-step movement that was used to scan above blocks of 8×8 pixels. This scanning pattern continues until the scan reaches the lower-right-most corner of the array, when every pixel has been scanned. However, it should be understood that the array need not be completely scanned to perform the filter logic. In fact, complete (non-substitution-see below) filter logic can be implemented as soon as two rows of pixels, and three pixels of a third row have been scanned and placed in the registers.

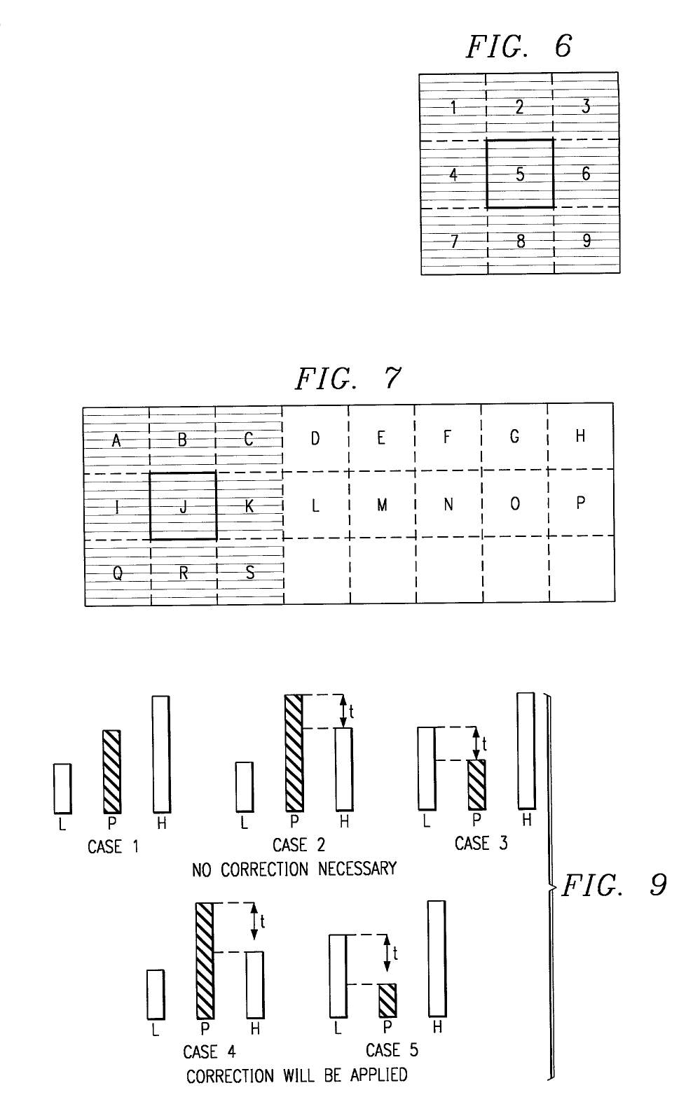

The OCADPF is designed to “filter” pixels in the sensor array that do not behave correctly, either due to manufacturing defects, or to debris, that may cause a pixel to always be either black or white. The pixels used for the comparison are shown FIG. 6, which illustrates an evaluation block—a bock of 3×3 pixels used for process pixel evaluation. The pixels numbered 1 through 9 are selected based on the line and column currently being processed. This will vary depending on whether the current pixel being processed (the process pixel) is on the first/last horizontal line of the block, the first last column (vertical line) of the block, or within the block. Within the block where all 9 pixels are available, the process pixel is compared with the surrounding 8 pixels.

When evaluating a process pixel, it is preferable to load into registers at least the first two horizontal rows of pixels, as well as at least three pixels in the third row of pixels. FIG. 7 illustrates the first three horizontal rows of a bock of 8×8 pixels. The pixels in the first two rows of pixels are labeled A-H, and I-P, respectively, and the first three pixels of the third row of pixels are likewise labeled Q-S. A shift register shifts the pixels through registers, preferably in a FIFO order. Accordingly, the pixels are shown in FIG. 7 as labeled PA (“Pixel A”) through PS, with the process pixel being processed residing in pixel register PJ. Pixels 1 through 9 are then selected as follows:

| | | | | | |
|---|---|---|---|---|---|
| P1 | = | PA | P2 | = | PB |
| P3 | = | PC | P4 | = | PI |
| P5 | = | PJ | P6 | = | PK |
| P7 | = | PQ | P8 | = | PR |
| P9 | = | PS | | | |

Substitution/Replacement of Pixels to Evaluate a Process Pixel

When the pixel being processed is on the first line there will not be a previous line to compare against, and thus the invention will have only five pixel values to evaluate. Accordingly, it is preferred that three additional pixel values be substituted for the missing pixel values. To simplify the selection of the replacement pixel values, it is preferred that at the boundaries of the 8×8 pixel blocks that the required 3×3 pixels are generated by substituting other pixels from the remaining (“active”) pixels within the 3×3 array.

In another embodiment, the replacement pixel could be calculated by finding the average value of 5 remaining pixels (in the case of an edge), or the average of 3 remaining pixels (in the case of a corner). This would require more complex dividers to divide by either 3 or 5 (dividing by 8 requires no logic gates-thus substitutions to provide a total of 8 pixel values are typically preferred for faster processing). In addition, replacing pixels for an 8-pixel approximation generally produces more accurate process pixel approximations than 5 or 3 pixel based approximations.

For the pixel being processed on the first line case, the following substitutions are suggested:

| | | |
|---|---|---|
| PA | = | PQ |
| PB | = | PR |
| PC | = | PS |

Similarly, when the pixel being processed is in the first column there will not be a previous column to compare against. In this case the following substitutions are suggested:

| | | |
|---|---|---|
| PA | = | PC |
| PI | = | PK |
| PQ | = | PS |

When the pixel being processed is in the last row there will not be a following row to compare against. In this case the following substitutions are suggested:

| | | |
|---|---|---|
| PQ | = | PA |
| PR | = | PB |
| PS | = | PC |

When the pixel being processed is in the last column there will not be a following column to compare against. In this case the following substitutions are suggested:

| | | |
|---|---|---|
| PC | = | PA |
| PK | = | PI |
| PS | = | PQ |

Using the above substitutions corner conditions can be accommodated by cascading horizontal and vertical condition checking, and provides the following possibilities:

| | | |
|---|---|---|
| P1 | = | PA or PC or PQ |
| P2 | = | PB or PR |
| P3 | = | PC or PA or PS |
| P4 | = | PI or PK |
| P5 | = | PJ |
| P6 | = | PK or PI |
| P7 | = | PQ or PA or PS |
| P8 | = | PR or PB |
| P9 | = | PS or PC or PQ |

Of course, it should be understood that the substitutions listed above are suggestions only, and other substitutions may be made without departing from the scope of the invention. In addition, it should be understood that sometimes it will be desirable and beneficial to not make any substitutions at all. Accordingly, the pixels PA, PB, PC and PI may use the actual/original pixels, or substitute pixels. Furthermore, it should be noted that pixel substitution may be made for both comparison as well as for pixel value averaging purposes.

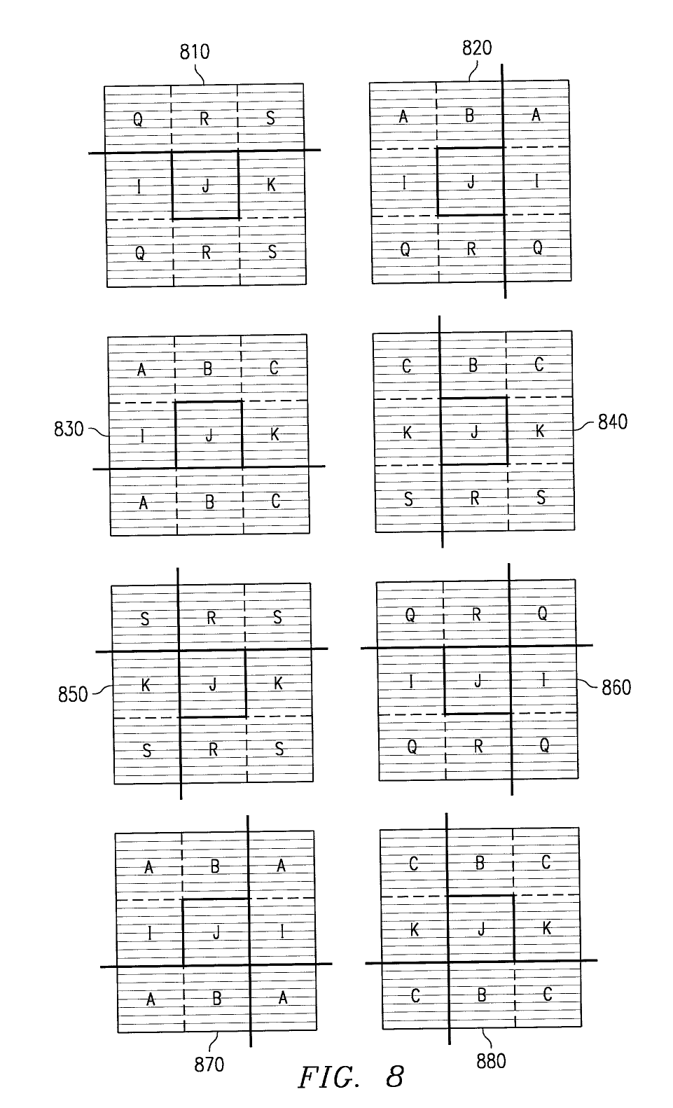

FIG. 8 shows the relationship between active pixels and substitution pixels at boundaries of an array, using the pixel designation provided for the 8×8 (m×n) pixel block of FIG. 7. Accordingly, a first block 810 illustrates the positioning and substitutions suggested for the case where the process pixel is positioned along the top of an array. A second block 820 illustrates the positioning and substitutions suggested for the case where the process pixel is positioned along the right side of an array. Similarly, third block 830 illustrates the positioning and substitutions suggested for the case where the process pixel is positioned along the bottom of an array, and a fourth block 840 illustrates the positioning and substitutions suggested for the case where the process pixel is positioned along the left side of an array.

A fifth block 850 shows the positioning and substitutions suggested for the case where the process pixel is positioned along the top-right-most corner of an array. Similarly, a sixth block 860 illustrates the positioning and substitutions suggested for the case where the process pixel is positioned along the top-right-most corner of an array. Likewise, a seventh block 870 shows the positioning and substitutions suggested for the case where the process pixel is positioned along the bottom-right-most corner of an array, and a eighth block 880 provides the positioning and substitutions suggested for the case where the process pixel is positioned along the bottom-left-most corner of an array.

FIG. 9 shows the possible pixel value relationships between adjacent pixels where L is the lowest pixel reading in the 8 adjacent pixels (including any substitution pixels), H is the highest pixel reading in the 8 adjacent pixels (including any substitution pixels), and P is the currently processed pixel. In FIG. 9, t is the value of the 2DOCADPF threshold. Preferably, t is selected by a user and programmed into the chip. In addition, it should be understood that although a single value of t is illustrated here, multiple values of t could be provided that are dependent upon factors such as position on the array, or whether the process pixel is being compared against a highest or a lowest pixel value.

Thus, the first three cases illustrated in FIG. 9 will not be corrected. Case 1 will not be corrected since the current pixel value is between the highest and the lowest adjacent pixel values. Case 2 will not be corrected since the current pixel is within ‘t’ of the highest adjacent pixel value (actually, it appears equal to t, which is a “no-correction” condition). Lastly, Case 3 will not be corrected since the current pixel is within ‘t’ of the lowest adjacent pixel value.

If the pixel is more than ‘t’ higher than the highest value or more than ‘t’ lower than the lowest value, then it is presumed to be defective and hence corrected. In FIG. 9, cases 4 and 5 will result in pixel value correction. Case 4 will be corrected since it is more than ‘t’ above the highest adjacent pixel value. Case 5 will be corrected since it is more than ‘t’ below the lowest adjacent pixel value. The value to which the pixel is corrected may be the horizontal average of the neighboring pixels, the average or the vertical neighboring pixels, the average of the horizontal and neighboring pixels, or the average of all neighboring pixels (other values may be used depending on the image characteristics).

Although the present invention and its advantages have been described in detail, it should be understood that various changes, substitutions and alterations can be made herein without departing from the spirit and scope of the invention as defined by the following claims.

What is claimed is:

1. A method of pixel filtering for CMOS imagers, comprising:
scanning each of a plurality of pixels within a block;
designating a pixel as a process pixel, the process pixel having adjacent pixels, the process pixel having a process pixel value, each of the adjacent pixels having an adjacent pixel value; and
comparing the process pixel value to at least one adjacent pixel value.

2. The method of claim 1 further comprising detecting a lowest pixel value among the adjacent pixels.

3. The method of claim 2 wherein comparing compares the process pixel value to a lowest pixel value.

4. The method of claim 3 further comprising resetting the process pixel to a new pixel value.

5. The method of claim 4 wherein the new pixel value is the average pixel value of the adjacent pixel values.

6. The method of claim 1 further comprising detecting a highest pixel value among the adjacent pixels.

7. The method of claim 6 wherein comparing compares the process pixel value to a highest pixel value.

8. The method of claim 7 further comprising resetting the process pixel value when the process pixel value is a predetermined value lower than the lowest pixel value.

9. The method of claim 3 further comprising resetting the process pixel value when the process pixel value is a predetermined value greater than the highest pixel value.

10. The method of claim 1 further comprising exposing an array to a light source so as to cast an image on the array, the array having at least one block.

11. The method of claim 10 wherein the array is generally grid-shaped.

12. The method of claim 1 wherein the block is generally grid-shaped.

13. The method of claim 12 wherein the block has nine pixels.

14 A chip that automatically filters defective pixels in a CMOS imager, comprising:
a plurality of registers; and
filter logic coupled to the registers.

15. The chip of claim 14 wherein the filter logic is capable of:
designating a pixel as a process pixel, the process pixel having adjacent pixels, the process pixel having a process pixel value, each of the adjacent pixels having an adjacent pixel value; and
comparing the process pixel value to at least one adjacent pixel value.

16. The chip of claim 15 further comprising an array coupled to the registers.

17. A method of on-chip pixel filtering for CMOS imagers, comprising:
scanning each of a plurality of pixels within a block for a pixel value;
loading a pixel value into a register;
using filter logic to designate a pixel as a process pixel, the process pixel having adjacent pixels, the process pixel having a process pixel value, each of the adjacent pixels having an adjacent pixel value; and
using filter logic to compare the process pixel value to at least one adjacent pixel value.

18. The method of claim 17, wherein the filter logic compares the process pixel value to a highest pixel value, further comprising:
detecting the highest pixel value among the adjacent pixels; and
resetting the process pixel value to a new process pixel value when the process pixel value is a predetermined value higher than the highest pixel value.

19. The method of claim 1, wherein the filter logic compares the process pixel value to a lowest pixel value, further comprising:
detecting the lowest pixel value among the adjacent pixels; and
resetting the process pixel value to a new process pixel value when the process pixel value is a predetermined value lower than the lowest pixel value.

20. The method of claim 19 wherein the new process pixel value is the average pixel value of the adjacent pixel values.
